(19) United States
(12) Patent Application Publication
(10) Pub. No.: US 2010/0307035 A1
(43) Pub. Date: Dec. 9, 2010

(54) Memorabilia Device

(76) Inventor: Alex Malone, Austin, TX (US)

Correspondence Address: LARSON NEWMAN & ABEL, LLP, 5914 WEST COURTYARD DRIVE, SUITE 200, AUSTIN, TX, 78730, US

(21) Appl. No.: 12/478,541

(22) Filed: Jun. 4, 2009

(51) Int. Cl. A44C 3/00; G09F 5/00; G09F 9/00

(52) U.S. Cl. 40/1; 40/1.5

(57) ABSTRACT

A device including a body. The body includes a first location, a second location, and a third location. The first location is operable to receive and to secure a first piece of memorabilia to the device. The second location has a team logo associated with the first piece of memorabilia. The third location has an inscription identifying the first piece of memorabilia. The device is configured to be worn by an individual.

### FIELD OF THE DISCLOSURE

This disclosure relates generally to memorabilia, and more particularly to a memorabilia device.

### BACKGROUND

Individuals like to collect and display different types of memorabilia. Different types of memorabilia include sports memorabilia and personal memorabilia. Sports memorabilia can be anything associated with a particular sport, a particular team, a particular player, and the like. Personal memorabilia can be anything associated with a person, a place, a family, an event, an occasion, and the like. Upon getting or keeping a piece of memorabilia the person may keep the piece of memorabilia in a place that is easily viewable and/or accessible to the individual.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a schematic diagram of a front view of a key chain with memorabilia attached thereon;

FIG. 2 is a schematic diagram of a side view the key chain of FIG. 1;

FIG. 3 is a schematic diagram of a back view the key chain of FIG. 1;

FIG. 4 is a schematic diagram of a perspective view of a bracelet with memorabilia attached thereon;

FIG. 5 is a schematic diagram of a side view the bracelet of FIG. 3;

FIG. 6 is a schematic diagram of a back view the bracelet of FIG. 3;

FIG. 7 is a schematic diagram of a front surface of a dog tag/pendant with memorabilia attached thereon;

FIG. 8 is a schematic diagram of a back surface of the dog tag/pendant of FIG. 7;

FIG. 9 is a schematic diagram of a perspective view of a tie clip with memorabilia attached thereon; and

FIG. 10 is a flow diagram of a method for attaching a piece of memorabilia to a device.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

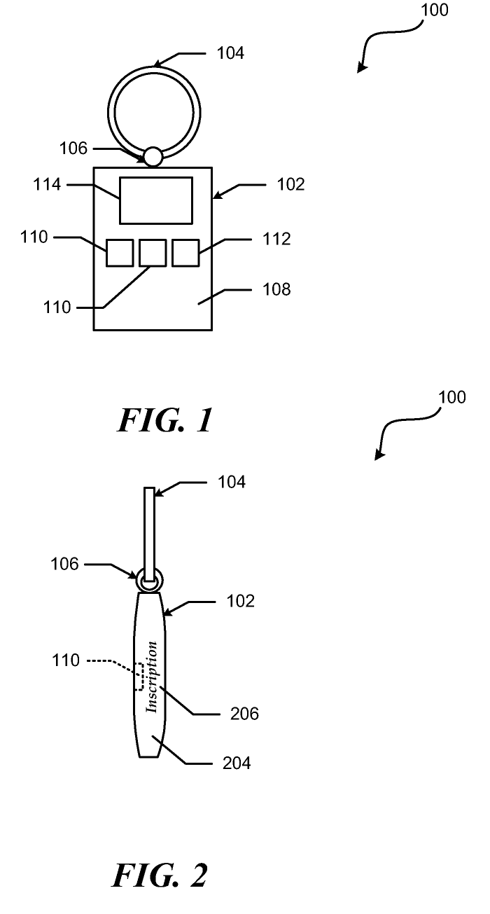

FIGS. 1-3 show a memorabilia key chain 100 including a device/fob 102, a ring 104, and a connector 106. The device/fob 102 includes a front surface 108, pieces of memorabilia 110, a recess portion 112, and a memorabilia location 114. The device/fob 102 is in physical communication with the connector 106. The connector 106 can be mounted on the device/fob 102 either by the connector having a screw (not shown) that it inserted into the device/fob or the connector being soldered to the device/fob. The ring 104 is in physical communication with the connector 106 via the ring being inserted through an opening 202 of the connector shown in FIG. 2. The ring 104 is operable to hold to one or more keys.

In FIG. 1, the pieces of memorabilia 110 can be secured to the front surface 108 of the memorabilia key chain via the recess portion 112. The pieces of memorabilia 110 can be cut from a larger item of memorabilia, such as but not limited to a game worn jersey, a game worn uniform, a game used hockey puck, a game used baseball, a game used football, a game used base, a game used hockey stick, a game used baseball bat, an autographed item, baby clothes, pictures, and/or any other item an individual chooses. The piece of memorabilia 110 can be cut to the size of the recess portion 112, then encased in a memorabilia module, and then pressed onto the recess portion so that the piece of memorabilia is securely attached to the device/fob 102.

The memorabilia module is self contained with a viewable area for the piece of memorabilia 110, as well as including a bar-code and serial number, security hologram, and memorabilia identification. The memorabilia module can be made in standard sizes to allow the memorabilia module to be independently made and placed within the recess portion 112 of the device/fob 102. The memorabilia module also can snap fit within the recess portion 112, and can include text associated with the piece of memorabilia 110, such as a player's name. In another embodiment, the piece of memorabilia 110 can be directly secured within the recess portion 112. Upon the piece of memorabilia 110 being secured within the recess portion 112, the piece of memorabilia is connected to the device/fob 102 of the memorabilia key chain 100.

The memorabilia item 114 can be any item associated with the associated with the pieces of memorabilia 110, such as a sports team logo associated with a game worn jersey. The memorabilia item 114 can be text written directly on the device/fob 102, can be a sticker or other material secured on the device/fob, and the like. In addition to a logo, the memorabilia item 114 can also be a player name, a player number, a year, a team name, a game description, a score, and the like.

In FIG. 2, the device/fob 102 also includes a side surface 204 which in turn includes an inscription 206. The inscription 206 can be engraved into the side surface 204 and lined up with the piece of memorabilia 110. The inscription 206 can be any text associated with the piece of memorabilia such as a player name, a player number, a year, a team name, a game description, a score, and the like. In different embodiments, the inscription 206 can be located on any side surface 204, on a back surface 302, or on the front surface 108. Additionally, there can be multiple inscriptions 206 associated with each piece of memorabilia 110 and/or an inscription associated with each piece of memorabilia.

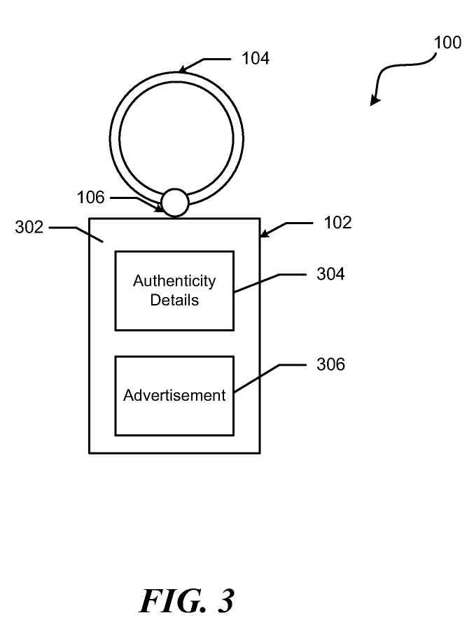

In FIG. 3, the device/fob 102 includes the back surface 302 which in turn includes authenticity details 304 and an advertisement 306. The authenticity details 304 is permanently affixed to the back surface 304 so that if an individual purchases the memorabilia key chain 100, he or she can have a verification that the pieces of memorabilia 110 are actually what they are claimed to be. The authenticity details 304 can be any information about the pieces of memorabilia 110, such as a print run number, a serial number, a statement that the items are authenticate, and the like. The authenticity details 304 can be all in one location and/or can be located at various locations on the device/fob 102. Additionally, the authenticity details 304 can be text written directly on the back surface 302, can be a material that is secured on the device/fob 102, and the like. The advertisement 306 can be placed on the back surface 302 to promote a company.

For example, if a baseball team wanted to give away memorabilia key chains 100, the team could put a sponsor's name on the back surface 302 as the advertisement 306 to pay for the cost of the memorabilia key chains. The team could also put game used bases, baseballs, bats, or jerseys as the pieces of memorabilia 110, the team logo as the memorabilia item 114, and a game description as the inscription 206. The advertisement 306 can be text written directly on the back surface 302, can be a sticker or other material secured on the device/fob 102, and the like.

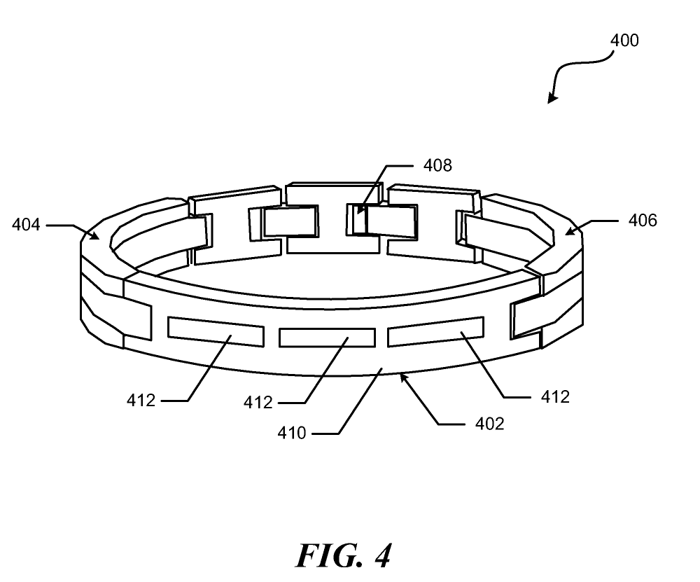

FIG. 4 shows a memorabilia bracelet 400 including a main section 402, a first strap 404, a second strap 406, and a clasp 408. The first strap 404 is in physical communication with an edge of the main section 402 and the second strap 406 is in physical communication with another edge of the main section. The clasp 408 is in physical communication with either the first strap 404 or the second strap 406 and is operable to connect with the other strap so that the memorabilia bracelet can be secured around an individual's wrist.

The main section 402 includes a front surface 410 which in turn includes pieces of memorabilia 412. The pieces of memorabilia 412 can be secured to the front surface 410 via a recess portion similar to the recess portion 112 of FIG. 1. The pieces of memorabilia 412 can be cut from a larger item of memorabilia, such as but not limited to a game worn jersey, a game worn uniform, a game used hockey puck, a game used baseball, a game used football, a game used base, a game used hockey stick, a game used baseball bat, an autographed item, baby clothes, pictures, and/or any other item an individual chooses. The piece of memorabilia 412 can be cut to the size of the recess portion on the memorabilia bracelet 400, and then inserted within the recess portion as described above so that the piece of memorabilia is securely attached to the front surface 410. Upon the piece of memorabilia 412 being secured, the piece of memorabilia is connected to the main section 402 of the memorabilia bracelet 400.

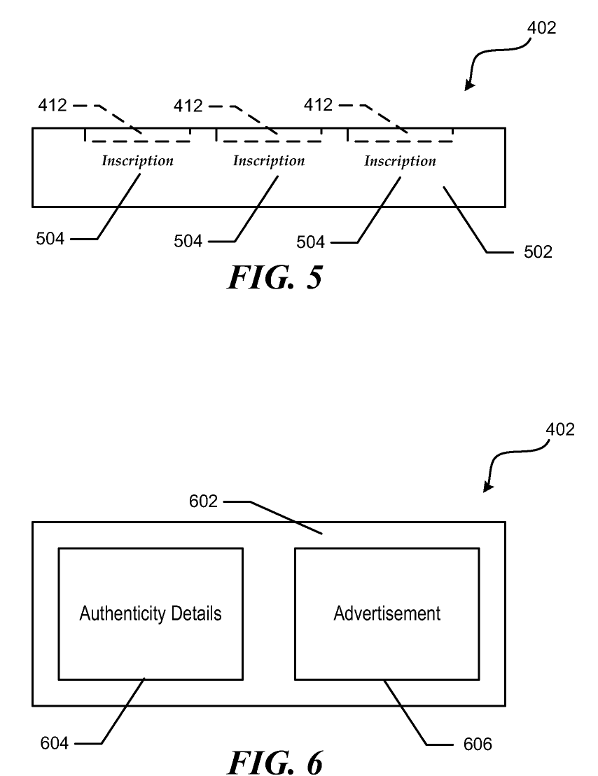

FIGS. 5 and 6 show the main section 402 of the memorabilia bracelet 400 of FIG. 4. In FIG. 5, the main section 402 includes a side surface 502 which in turn includes inscriptions 504. The inscriptions 504 can be engraved into the side surface 502 and each inscription can be lined up with one of the pieces of memorabilia 412. The inscription 504 can be any text associated with the piece of memorabilia 412 such as a player name, a player number, a year, a team name, a game description, a score, and the like. In different embodiments, the inscription 504 can be located on any side surface 502, on a back surface 602, or on the front surface 410.

In FIG. 6, the main section 402 includes a back surface 602 which in turn includes authenticity details 604 and an advertisement 606. The authenticity details 604 is permanently affixed to the back surface 604 so that if an individual purchases the memorabilia bracelet 400, he or she can have a verification that the pieces of memorabilia 412 are actually what they are claimed to be. The authenticity details 604 can be text written directly on the back surface 302, can be a material that is secured on the device/fob 102, and the like. The advertisement 606 can be placed on the back surface 602 to promote a company. The advertisement 606 also can be text written directly on the back surface 602, can be a sticker or other material secured on the main section 402, and the like.

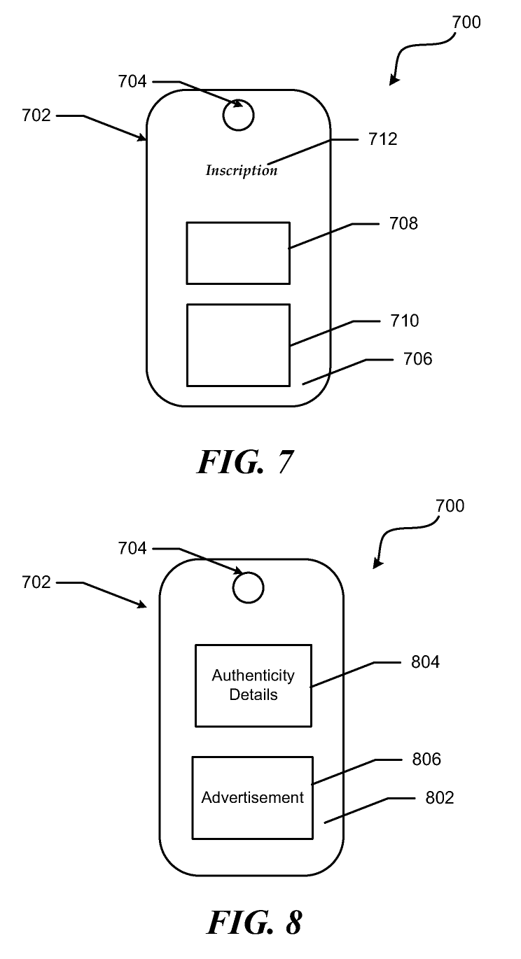

FIGS. 7 and 8 show a memorabilia dog tag/pendant 700 including a main section 702 and an eye 704. The eye 704 is operable to hold the memorabilia dog tag/pendant 700 on a chain or necklace (not shown). In FIG. 7, the main section 702 includes a front surface 706 which in turn includes a piece of memorabilia 708, a memorabilia item 710, and an inscription 712. The piece of memorabilia 708 can be cut from a larger item of memorabilia, such as a game worn jersey, a game used hockey puck, a game used baseball, a game used football, a game used base, baby clothes, pictures, and/or any other item an individual chooses. The piece of memorabilia 708 can be cut to the size of a recess portion, and then inserted within the recess portion as described above so that the piece of memorabilia is securely attached to the front surface 706. Upon the piece of memorabilia 708 being secured, the piece of memorabilia is connected to the front surface 706 of the memorabilia dog tag/pendant 700.

The memorabilia item 710 is any item associated with the associated with the pieces of memorabilia 708, such as a sports team logo associated with a game worn jersey. The memorabilia item 710 can be text written directly on the front surface 706, can be a sticker or other material secured on the front surface, and the like. In addition to a logo, the memorabilia item 710 can also be a player name, a player number, a year, a team name, a game description, a score, and the like. The inscription 712 can be engraved into the front surface 706. The inscription 712 can be any text associated with the piece of memorabilia such as a player name, a player number, a year, a team name, a game description, a score, and the like. In different embodiments, the inscription 712 can be located on the front surface 706 or on a back surface 802.

In FIG. 8, the main section 702 includes the back surface 802 which in turn includes authenticity details 804 and an advertisement 806. The authenticity details 804 is permanently affixed to the back surface 802 so that if an individual purchases the memorabilia dog tag/pendant 700, he or she can have a verification that the pieces of memorabilia 708 are actually what they are claimed to be. The authenticity details 804 can be text written directly on the back surface 802, can be a material that is secured on the back surface, and the like. The advertisement 806 can be placed on the back surface 802 to promote a company. The advertisement 806 also can be text written directly on the back surface 802, can be a sticker or other material secured on the back surface, and the like.

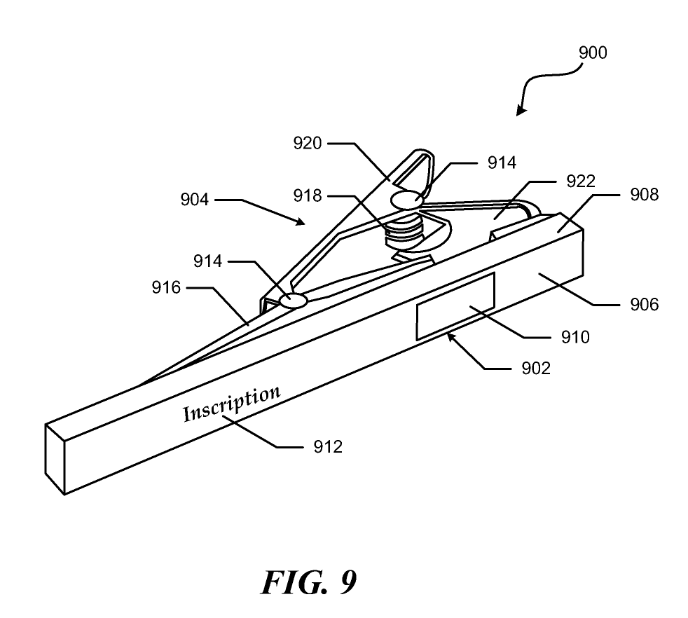

FIG. 9 shows a memorabilia tie clip 900 including a main section 902 and a clasp section 904. The main section 902 includes a front surface 906 and a side surface 908. The front surface 906 includes a piece of memorabilia 910 and an inscription 912. The clasp section 904 includes pins 914, a holder portion 916, a spring 918, a release portion 920, and a mounting portion 922. The clasp section 904 is secured to the main section 902 via the mounting portion 922. The memorabilia tie clip 900 is held in place by a tie being inserted between the main section 902 and the holder portion 916 of the clasp section 904. The spring 918 provides a force against the release portion 920 such that the holder portion 916 is held tightly against the tie and the main section 902. The memorabilia tie clip 900 is removed by a force being applied downwardly on the release portion 920 and the clasp section 904 rotating at the pins 914 until the force against the tie is released and the memorabilia tie clip can be removed.

The piece of memorabilia 910 can be cut from a larger item of memorabilia, such as but not limited to a game worn jersey, a game worn uniform, a game used hockey puck, a game used baseball, a game used football, a game used base, a game used hockey stick, a game used baseball bat, an autographed item, baby clothes, pictures, and/or any other item an individual chooses. The piece of memorabilia 910 can be cut to the size of a recess portion, and then inserted within the recess portion as described above so that the piece of memorabilia is securely attached to the front surface 906. Upon the piece of memorabilia 910 being secured, the piece of memorabilia is connected to the memorabilia tie clip 900.

The inscription 912 can be engraved into the front surface 906. The inscription 912 can be any text associated with the piece of memorabilia 910 such as a player name, a player number, a year, a team name, a game description, a score, and the like. In different embodiments, the inscription 912 can be located on the front surface 906 or on any side surface 908.

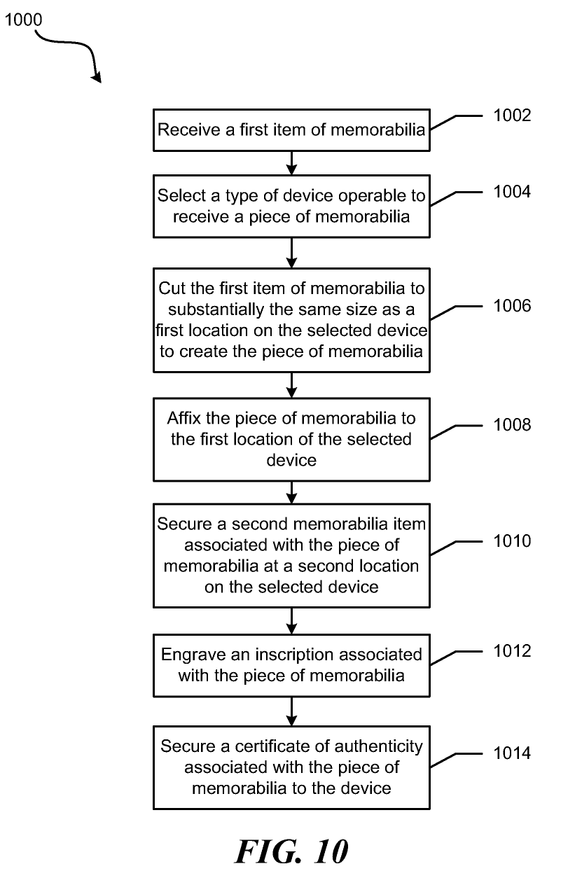

FIG. 10 shows a flow diagram of a method 1000 for securing a piece of memorabilia to a device. At block 1002, a first item of memorabilia is received. The first item of memorabilia can be a game worn jersey, a game used hockey puck, a game used baseball, a game used football, a game used base, baby clothes, pictures, and/or any other item an individual chooses. A type of device operable to receive a piece of memorabilia is selected at block 1004. The type of device can be a key chain, a bracelet, a dog tag/pendant, a tie clip, and the like.

At block 1006, the first item of memorabilia is cut to substantially the same size as a first location on the selected device to create a piece of memorabilia. The piece of memorabilia is affixed to the first location of the selected device at block 1008. The piece of memorabilia can be securely and permanently affixed within the first location of the device in any manner, such as with an adhesive, an epoxy, fasteners, snap fitting, and the like. At block 1010, a second memorabilia item associated with the piece of memorabilia is secured to the device. The second memorabilia item can a team logo, a player name, a player number, a year, a team name, a game description, a score, and the like. At block 1012, an inscription associated with the piece of memorabilia is engraved into the device. The inscription can be a player name, a player number, a year, a team name, a game description, a score, and the like. At block 1014, authenticity details associated with the piece of memorabilia is secured to the device.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A device comprising:
a body including:
a first location operable to receive and to secure a first piece of memorabilia to the device;
a second location having a team logo associated with the first piece of memorabilia; and
a third location having an inscription identifying the first piece of memorabilia;
wherein the device is configured to be worn by an individual.

2. The device of claim 1 wherein the body further includes:
a fourth location having authenticity details associated with the first piece of memorabilia.

3. The device of claim 1 further comprising:
a first strap extending from a first edge of the body;
a second strap extending from a second edge of the body; and
a clasp extending from the second strap, the clasp configured to connect the first strap with the second strap, and further configured to secure the device to be worn by the individual.

4. The device of claim 1 wherein the first location includes an adhesive material configured to permanently secure the first piece of memorabilia to the device.

5. The device of claim 1 wherein the body further includes:
a fourth location operable to receive and to secure a second piece of memorabilia.

6. The device of claim 5 wherein the second piece of memorabilia is selected from a player name, a player number, a year, a team name, a game description, a score, a team logo, or any combination thereof.

7. The device of claim 1 wherein the inscription is selected from a player name, a player number, a year, a team name, a game description, a score, or any combination thereof.

8. The device of claim 1 wherein the first piece of memorabilia is selected from a group consisting of a game worn jersey, a game worn uniform, a game used hockey puck, a game used baseball, a game used football, a game used base, a game used hockey stick, a game used baseball bat, an autographed item, baby clothes, and pictures.

9. A device comprising:
a body including:
a first location operable to receive and to secure a first piece of memorabilia to the device; and
a second location having an inscription identifying the first piece of memorabilia; and
a key ring extending from the body, the key ring configured to hold a key and to connect the key with the device.

10. The device of claim 9 wherein the body further includes:
a third location having authenticity details associated with the first piece of memorabilia.

11. The device of claim 9 wherein the first piece of memorabilia snap fits within the first location.

12. The device of claim 9 wherein the body further includes:
a third location operable to receive and to secure a second piece of memorabilia.

13. The device of claim 12 wherein the second piece of memorabilia is a player name, a player number, a year, a team name, a game description, a score, a team logo, or any combination thereof.

14. The device of claim 9 wherein the inscription is a player name, a player number, a year, a team name, a game description, a score, or any combination thereof.

15. The device of claim 9 wherein the first piece of memorabilia is selected from a group consisting of a game worn jersey, a game worn uniform, a game used hockey puck, a game used baseball, a game used football, a game used base, a game used hockey stick, a game used baseball bat, an autographed item, baby clothes, and pictures.

16. A method comprising:
receiving a piece of memorabilia
affixing the piece of memorabilia to a device configured to be worn by an individual;
inscribing an inscription identifying the piece of memorabilia on the device; and
securing a memorabilia item associated with the piece of memorabilia to the device.

17. The method of claim 16 wherein the first surface further includes:
securing authenticity details associated with the piece of memorabilia to the device.

18. The method of claim 17 wherein the memorabilia item is a player name, a player number, a year, a team name, a game description, a score, a team logo, or any combination thereof.

19. The method of claim 16 wherein the inscription is a player name, a player number, a year, a team name, a game description, a score, or any combination thereof.

20. The method of claim 16 wherein the piece of memorabilia is selected from a group consisting of a game worn jersey, a game worn uniform, a game used hockey puck, a game used baseball, a game used football, a game used base, a game used hockey stick, a game used baseball bat, an autographed item, baby clothes, and pictures.
